(19) United States
(12) Patent Application Publication
(10) Pub. No.: US 2017/0213304 A1
(43) Pub. Date: Jul. 27, 2017

(54) System And Method Of Providing Firm Cash Offers For Uninspected Assets

(71) Applicant: Kurt Carlton, Irving, TX (US)

(72) Inventor: Kurt Carlton, Irving, TX (US)

(21) Appl. No.: 15/004,918

(22) Filed: Jan. 23, 2016

(51) Int. Cl. G06Q 50/16; G06Q 30/04; G06Q 30/02

(52) U.S. Cl. CPC G06Q 50/167; G06Q 30/0283; G06Q 30/04

(57) ABSTRACT

A method of providing firm cash offers for uninspected assets is provided. The method comprises a computer generating and transmitting an offer to purchase an uninspected asset, the offer comprising a range of contingent purchase prices based on results of a future inspection of the asset, the computer determining the contingent purchase prices using at least one algorithm, and one of the contingent purchase prices becoming a firm cash purchase price upon completion of the inspection. The method also comprises the computer receiving acceptance of the offer, the acceptance agreeing to sell the asset for the firm purchase price determined based on results of the inspection. The method also comprises the computer closing, upon completion of the inspection, purchase of the asset at the firm purchase price determined based on the inspection and further, based on proceeds realized during subsequent liquidation of the asset, refining the at least one algorithm.

### CROSS REFERENCE TO RELATED APPLICATIONS

None

### FIELD OF THE DISCLOSURE

The present disclosure is in the field of expediting large transactions on electronic platforms. More particularly, the present disclosure is in the technical field providing sellers of large uninspected assets a range of contingent purchase prices based on asset condition and rapidly funding transactions after inspection.

### BACKGROUND OF THE DISCLOSURE

Parties selling large assets, for example residential real estate, seek to realize the best value from their sales with a minimum investment of time and expense. Selling one's home can become a time consuming and onerous process. Extensive dealings with real estate brokers and prospective buyers visiting and viewing one's home, often on short notice, can become stressful for a seller. Further, negotiations with buyers can become drawn out. Buyers can encounter problems with securing mortgage financing due to credit and other problems. The seller may encounter unexpected expense in making repairs and improvements and incurring legal fees. If the seller is moving to another city for a job change, for example, the seller may have to relocate to the new city before the seller's home in the previous city is sold, complicating the seller's financial situation and presenting logistical challenges to the seller at a time when the seller wishes to concentrate on his or her new job. Consequently, a need is perceived to streamline and simplify the process of selling residential real estate.

### SUMMARY OF THE DISCLOSURE

In an embodiment, a method of providing firm cash offers for uninspected assets is provided. The method comprises a computer generating and transmitting an offer to purchase an uninspected asset, the offer comprising a range of contingent purchase prices based on results of a future inspection of the asset, the computer determining the contingent purchase prices using an at least one algorithm, and one of the contingent purchase prices becoming a firm cash purchase price upon completion of the inspection. The method also comprises the computer receiving an acceptance of the offer, the acceptance agreeing to sell the asset for the firm purchase price to be determined based on the results of the inspection. The method also comprises the computer closing, upon completion of the inspection, purchase of the asset at the firm purchase price determined based on the inspection. The method also comprises the computer, based on proceeds realized during subsequent liquidation of the asset, refining the at least one algorithm.

In an embodiment, a system of providing firm cash offers for uninspected assets is provided. The system comprises a processor, a memory, and an application stored in the memory that, when executed on the processor generates and transmits an offer to purchase an uninspected asset, the offer comprising a range of contingent purchase prices based on results of a future inspection of the asset, the contingent purchase prices determined using an at least one algorithm, and one of the contingent purchase prices becoming a firm cash purchase price upon completion of the inspection. The system also receives an acceptance of the offer, the acceptance agreeing to sell the asset for the firm purchase price to be determined based on the results of the inspection. The system also closes, upon completion of the inspection, purchase of the asset at the firm purchase price determined based on the inspection. The system also, based at least on proceeds realized during subsequent liquidation of the asset, refines the at least one algorithm.

In an embodiment, a method of providing firm cash offers for uninspected assets is provided. The method comprises a computer receiving a request for an offer to purchase an uninspected asset, the asset comprising at least one item of real property. The method also comprises the computer accessing a first set of information sources for a first data to provide to at least one algorithm for generating the purchase offer, the first set of information sources comprising multiple listing services and property tax records. The method also comprises the computer determining that the first data is inadequate to generate the offer. The method also comprises the computer accessing a second set of information sources for a second data to provide to the at least one algorithm for generating the offer, the second data comprising at least one of physical dimensions of the real property, type of construction of the real property if any, and information about similar and neighboring properties. The method also comprises the computer generating and communicating the offer based at least on processing by the at least one algorithm of the second data, the offer containing a range of contingent purchase prices based on results of a future inspection of the asset, wherein one of the contingent purchase prices becomes a firm cash purchase price upon completion of the inspection.

### BRIEF DESCRIPTION OF THE DRAWINGS

FIG. 1 depicts a block diagram of a system of providing firm cash offers for uninspected assets according to an embodiment of the present disclosure.

FIG. 2 depicts a flowchart of a method of providing firm cash offers for uninspected assets according to an embodiment of the present disclosure.

FIG. 3 depicts a flowchart of a method of providing firm cash offers for uninspected assets according to an embodiment of the present disclosure.

### DETAILED DESCRIPTION OF THE INVENTION

The present disclosure provides systems and methods for evaluating assets for potential purchase prior to physical inspection of the assets. Based at least on access to widely accessible information sources and specialized analysis of selected data drawn from the sources, a set of contingent purchase offers is provided, prior to inspection, to prospective sellers of the assets. The set of contingent offers is based on a range of potential results of physical inspection of the property, expressed in terms of the property's condition. The property may be items of residential real estate. The contingent offers are for cash purchase of the property to be completed on an expedited basis.

Upon the prospective seller accepting this arrangement of a series of offers contingent upon inspection, the property is inspected. Based on inspected condition, the contingent offer of the set of contingent offers corresponding to the condition found upon inspection becomes the actual price for the sale of the property. The transaction may then be finalized and closed.

Systems and methods provide for accessing extensive information sources including multiple listing services and property tax records. Data from these sources is incorporated into evaluations of properties not yet inspected. At least one algorithm provided herein analyzes the data and assists in determining the set of contingent amounts to offer to a prospective seller based on pending inspection. When a property acquired using a valuation generated by the algorithm is subsequently liquidated and proceeds are realized, the results and insights gained therefrom may be used to refine the algorithm.

Parties interested in disposing of property in a safe and expedient manner may electronically contact an entity, for example a real estate investment firm, that implements the systems and methods provided herein. Such prospective selling parties may initiate contact via Internet connection to a World Wide Web site or other venue provided by the investment firm. The firm's website may offer to pay cash for real estate with an instant cash offer based on, for example, five possible conditions of the subject property, the condition to be determined after inspection. The five possible conditions may be unlivable, poor, average, good, and excellent.

Investment firms and others may seek to acquire properties on such an expedient basis for immediate liquidation, for long term investment, or for other purposes. Such entities may operate specialized systems including hardware components that execute software including the at least one algorithm described above. The specialized systems may aid in evaluating candidate properties for investment. The software, which may be an application executing on a server, may receive the street address or other identifying information about the property from the prospective seller via Internet communication from the prospective seller. The application, which includes or has access to the algorithm, draws upon multiple listing service information and property tax information to develop its set of cash offers to the prospective seller based in part on possible physical conditions to be determined after inspection.

As noted, the investment firm or other entity may subsequently liquidate properties they acquire earlier using at least systems and methods provided herein. Based on proceeds realized and other results of the liquidations, the investment firm may refine the algorithm, for example altering weights applied to inputs or changing at least some of the inputs altogether. Such adjustments may allow the algorithm to more accurately predict values of uninspected properties.

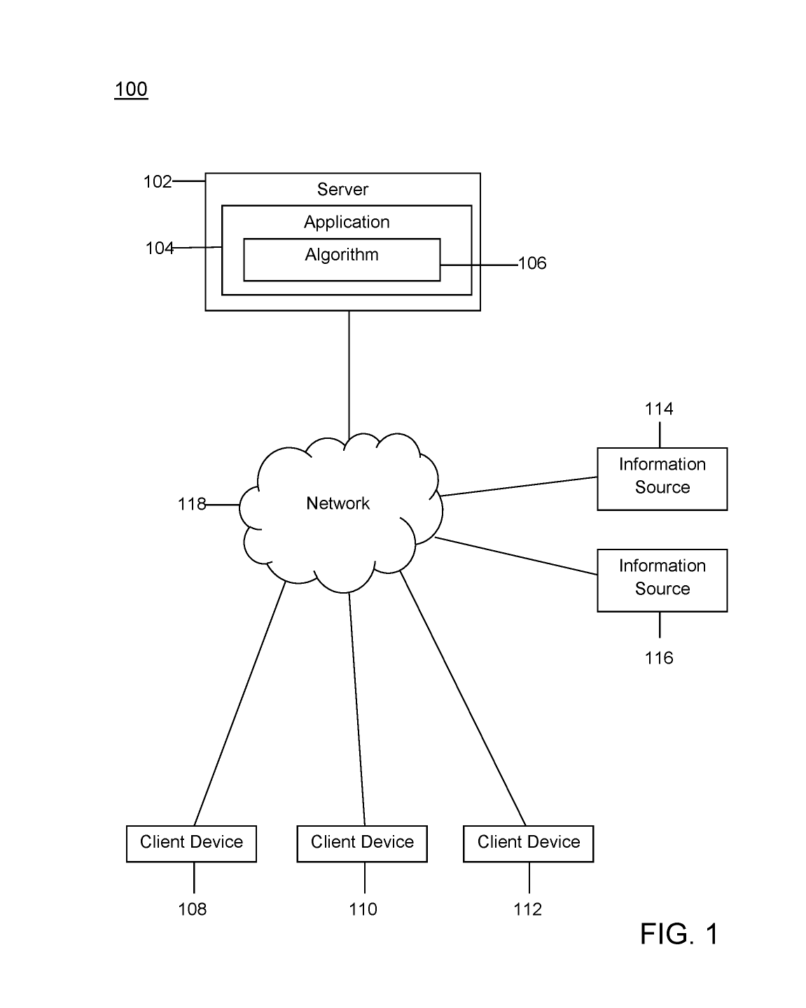

Turning to the figures, FIG. 1 depicts a block diagram of a system of providing firm cash offers for uninspected assets according to an embodiment of the present disclosure. FIG. 1 illustrates a system 100 provided herein comprising a server 102, application 104, algorithm 106, client devices 108, 110, 112, information sources 114, 116, and a network 118.

The server 102 is a computer system. Computer systems are described in detail hereinafter. The server 102 may be operated or otherwise controlled by an entity, for example an investment firm or asset manager, seeking to purchase assets. The assets may be items of real property. In embodiments, the server 102 is more than one computer system and includes additional hardware as well as software necessary to host an Internet web site simultaneously accessible by a large quantity of client devices 108, 110, 112 that require rapid responses to their inquiries.

The application 104 executes at least on the server 102. The application 104 receives, processes, and replies to messages sent by the client devices 108, 110, 112 sent via the World Wide Web or other medium. The messages from the client devices 108, 110, 112 may be submitted via web browsers or other software while accessing a website or other electronic venue hosted by the server 102. The messages may be sent by the client devices 108, 110, 112 requesting offers from the entity for properties that parties associated with the client devices 108, 110, 112 may wish to sell. The application 104 encompasses web-based and server-based software used to provide for a large quantity of client devices 108, 110, 112 to contact the system 100 and receive rapid and full service.

The algorithm 106 is a set of mathematical functions executed as part of the application 104. In an embodiment, more than one algorithm 106 may be used by the application 104. Remarks herein about the algorithm 106 are applicable to embodiments involving two or more algorithms 106. The algorithm 106 assists in generating valuations of assets, including items of real property, which have not yet been physically inspected. The algorithm 106 receives inputs from at least one information source 114, 116 and performs mathematical, statistical, and other operations on the inputs. The inputs may be information about a subject property, information about similar or nearby properties, or may be information not directly related to properties but still of use in evaluating the subject property. The algorithm 106 may apply weights or apply other statistical factors to inputs while subjecting the inputs to various mathematical operations.

As noted, the server 102 and the application 104 executing thereon receive a large flow of web based inquiries from client devices 108, 110, 112. The inquiries contain at least street address information for properties that parties using the client devices 108, 110, 112 may be considering for sale. The application 104 seeks to provide a range of contingent offers in response to each inquiry. Each of the contingent offers in the range of contingent offers is associated with physical conditions that may be discovered upon inspection. The discovered physical conditions may be one of unlivable, poor, average, good, and excellent. In an embodiment, other designations for physical conditions may be used. The investment firm or other entity operating the server 102, not having yet physically viewed a subject property and therefore relying upon the information sources 114, 116, seeks to provide contingent cash offers that will accurately align with the conditions of the property but also be attractive to the prospective seller using a client device 108, 110, 112. The investment firm seeks to induce the seller to accept the arrangement described herein.

Since the property has not been inspected and its actual condition is not known, the application 104 attempts to be accurate in its evaluations based on all five potential conditions. It is not enough for the system 100 to provide accurate cash offers based, for example, on assumed unlivable, average, and perfect conditions while accompanying cash offers for poor and good conditions miss their marks and may lead the entity into an unprofitable situation should the property turn out to be in either poor or good condition. A central task of the system 100 is to choose the appropriate information sources 114, 116 to draw upon in a given situation but also apply the algorithm 106 properly so that all five of the contingent offers contained in a response back to the requesting client device 108, 110, 112 are accurate. In embodiments, accuracy entails selecting the correct data to evaluate but also properly applying statistical methods of at least the algorithm 106 such that the range of offers is both attractive to the seller and likely to result in a profitable situation for the entity.

The information sources 114, 116 are publicly and privately available databases and other repositories of information about real property. In an embodiment, the real property is residential property. The information sources 114, 116 may be a multiple listing service (MLS). An MLS is a suite of services that provides as a facility for orderly correlation and dissemination of property listing information to better serve various parties to real estate transactions. An MLS enables parties to establish contractual offers of compensation among themselves and may accumulate and disseminate information to enable valuations and other services.

Information sources 114, 116 may also comprise property tax records and other public records wherein transactions and other information involving real estate are recorded. The application 104 may access tax records regarding title matters, sale transactions, property conditions, liens and encumbrances, and valuations. The tax records may be provided by databases operated by public taxing entities or private providers of property tax and associated data.

Information sources 114, 116 may also be commercial aggregators and providers of information about real property. They may be banks, lenders, mortgage brokers, accountants, or attorneys that gather and process information about real property.

In an embodiment, a property may never have been subject to a sale and purchase transaction or may have been subject to such transactions so many years prior that traditional information sources 114, 116 such as multiple listing services and property tax records may not provide useful information. Other information sources 114, 116 may have to be drawn upon by the server 102 for assistance. The other information sources 114, 116 may provide information including dimensions of subject property, type of construction, and information, including recent transactions, about similar and neighboring properties to the subject property. The algorithm 106 may be modified or adapted to incorporate data from such information sources 114, 116.

The client devices 108, 110, 112 are used by parties that may seek to sell items of real property to a real estate investment firm or other entity operating the server 102 and application 104. The client devices 108, 110, 112 may be desktop computers, laptop computers or wireless devices including cell phones. Such client devices 108, 110, 112 may be web enabled with Internet browser software or other network access capability to enable the client devices 108, 110, 112 to contact the computer 102. Client devices 108, 110, 112 may, via the Internet, access web pages provided by the server 102 wherein the client devices 108, 110, 112 may enter the address of a property for sale and receive contingent cash offers for the property as provided herein.

The network 118 promotes communication between the components of the system 100. The network 118 may be any communication network including a public data network (PDN), a public switched telephone network (PSTN), a private network, and/or a combination thereof.

Aspects of the system 100 described above may be implemented on a computer system with sufficient processing power, memory resources, and network throughput capability to handle the necessary workload placed upon it. The computer system includes a processor (which may be referred to as a central processor unit or CPU) that is in communication with memory devices including secondary storage, read only memory (ROM), random access memory (RAM), input/output (I/O) devices, and network connectivity devices. The processor may be implemented as one or more CPU chips.

Secondary storage is typically comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage.

I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), and/or worldwide interoperability for microwave access (WiMAX) radio transceiver cards, and other well-known network devices. These network connectivity devices may enable the processor to communicate with an Internet or one or more intranets. With such a network connection, it is contemplated that the processor might receive information from the network, or might output information to the network in the course of performing the above-described method steps. Such information, which is often represented as a sequence of instructions to be executed using processor, may be received from and outputted to the network, for example, in the form of a computer data signal embodied in a carrier wave.

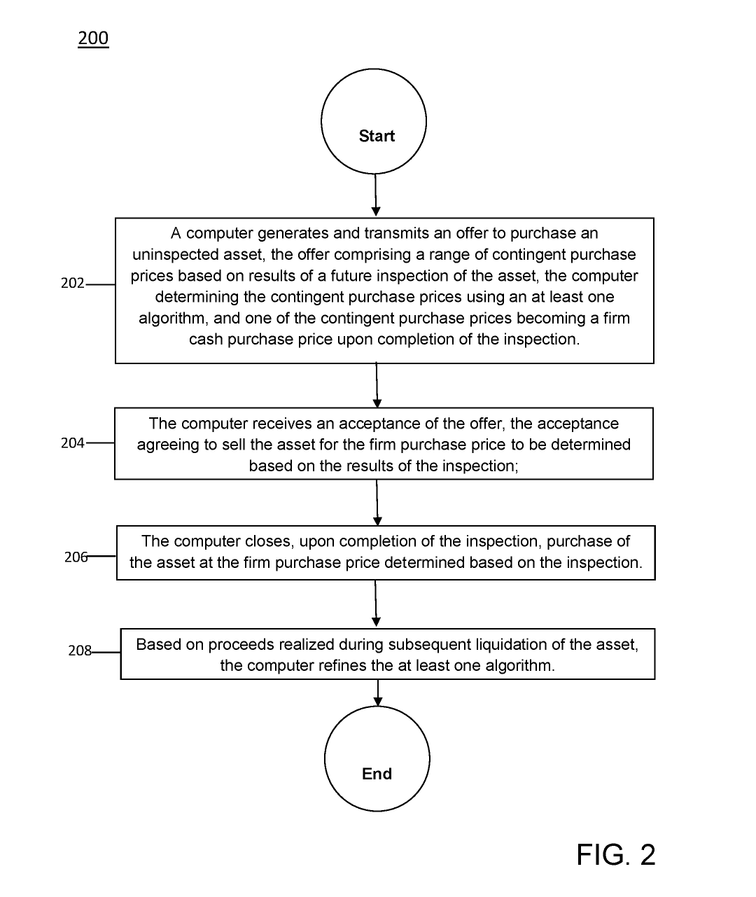

FIG. 2 depicts a flowchart of a method 200 of providing firm cash offers for uninspected assets according to an embodiment of the present disclosure. The method 200 may use components provided by system 100. Beginning at block 202, a computer generates and transmits an offer to purchase an uninspected asset, the offer comprising a range of contingent purchase prices based on results of a future inspection of the asset, the computer determining the contingent purchase prices using at least one algorithm, and one of the contingent purchase prices becoming a firm cash purchase price upon completion of the inspection.

At block 204, the computer receives an acceptance of the offer, the acceptance agreeing to sell the asset for the firm purchase price to be determined based on the results of the inspection. At block 206, the computer closes, upon completion of the inspection, purchase of the asset at the firm purchase price determined based on the inspection. At block 208, based on proceeds realized during subsequent liquidation of the asset, the computer refines the at least one algorithm. The method 200 terminates thereafter.

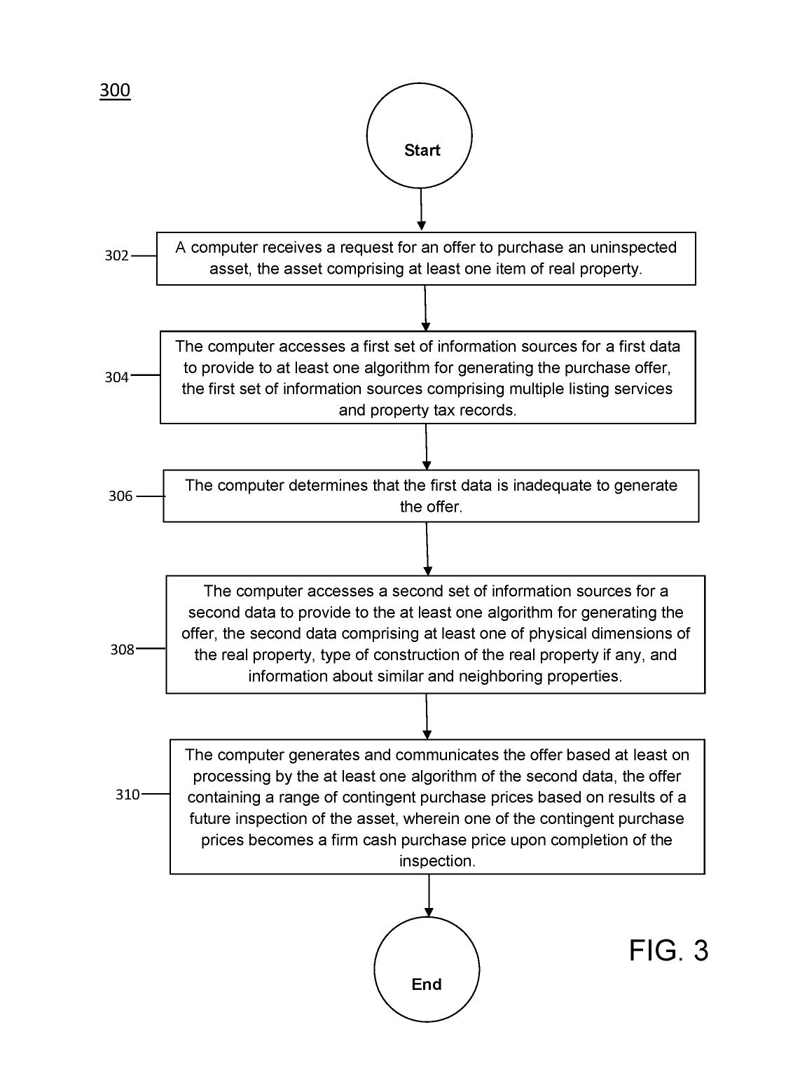

FIG. 3 depicts a flowchart of a method of providing firm cash offers for uninspected assets according to an embodiment of the present disclosure. The method 200 may use components provided by system 100. Beginning at block 302, a computer receives a request for an offer to purchase an uninspected asset, the asset comprising at least one item of real property. At block 304, the computer accesses a first set of information sources for a first data to provide to at least one algorithm for generating the purchase offer, the first set of information sources comprising multiple listing services and property tax records.

At block 306, the computer determines that the first data is inadequate to generate the offer. At block 308, the computer accesses a second set of information sources for a second data to provide to at least one algorithm for generating the offer, the second data comprising at least one of physical dimensions of the real property, type of construction of the real property if any, and information about similar and neighboring properties. At block 310, the computer generates and communicates the offer based at least on processing by the at least one algorithm of the second data, the offer containing a range of contingent purchase prices based on results of a future inspection of the asset, wherein one of the contingent purchase prices becomes a firm cash purchase price upon completion of the inspection. The method 300 terminates thereafter.

What is claimed is:

1. A method of providing firm cash offers for uninspected assets comprising:
a computer generating and transmitting an offer to purchase an uninspected asset, the offer comprising a range of contingent purchase prices based on results of a future inspection of the asset, the computer determining the contingent purchase prices using an at least one algorithm, and one of the contingent purchase prices becoming a firm cash purchase price upon completion of the inspection;
the computer receiving an acceptance of the offer, the acceptance agreeing to sell the asset for the firm purchase price to be determined based on the results of the inspection;
the computer closing, upon completion of the inspection, purchase of the asset at the firm purchase price determined based on the inspection; and
based on proceeds realized during subsequent liquidation of the asset, the computer refining the at least one algorithm.

2. The method of claim 1, wherein the asset comprises at least one item of real property.

3. The method of claim 1, further comprising the computer causing the at least one algorithm to evaluate a plurality of inputs regarding at least the asset, the inputs comprising at least one of multiple listing service information and property tax record information.

4. The method of claim 1, wherein the range of contingent purchase prices comprises five contingent purchase prices, each of the contingent purchase prices based on one of unlivable, poor, average, good, and excellent conditions of the asset determined based on the inspection.

5. The method of claim 1, further comprising the computer refining the at least one algorithm comprising at least adjusting levels of reliance on data sources and weights placed on inputs to the algorithm.

6. The method of claim 5, wherein the computer refining the at least one algorithm further comprises the computer continually modifying the at least one algorithm based on results of purchases and liquidations of assets.

7. The method of claim 1, further comprising the computer generating and transmitting the offer in response to an inquiry received via the world wide web of the Internet.

8. The method of claim 3, further comprising the computer one of additionally and alternatively analyzing size of the asset, type of construction of the asset if any, and information about similar and neighboring asset.

9. A system of providing firm cash offers for uninspected assets, comprising:
a processor;
a memory; and
an application stored in the memory that, when executed on the processor:
generates and transmits an offer to purchase an uninspected asset, the offer comprising a range of contingent purchase prices based on results of a future inspection of the asset, the contingent purchase prices determined using an at least one algorithm, and one of the contingent purchase prices becoming a firm cash purchase price upon completion of the inspection;
receives an acceptance of the offer, the acceptance agreeing to sell the asset for the firm purchase price to be determined based on the results of the inspection;
closes, upon completion of the inspection, purchase of the asset at the firm purchase price determined based on the inspection; and
based at least on proceeds realized during subsequent liquidation of the asset, refines the at least one algorithm.

10. The system of claim 9, wherein the asset comprises at least one item of real property.

11. The system of claim 9, wherein the application causes the at least one algorithm to evaluate a plurality of inputs regarding at least the asset, the inputs comprising at least one of multiple listing service information and property tax record information.

12. The system of claim 9, wherein the range of contingent purchase prices comprises five contingent prices, each of the contingent purchase prices based on one of unlivable, poor, average, good, and excellent conditions of the asset determined based on the inspection.

13. The system of claim 9, wherein the application further refines the at least one algorithm comprising at least adjusting, based on results of purchases and liquidations of assets, levels of reliance on data sources and weights placed on inputs to the at least one algorithm.

14. The method of claim 9, wherein the application generates and transmits the offer in response to an inquiry received via the world wide web of the Internet.

15. A method of providing firm cash offers for uninspected assets, comprising:
a computer receiving a request for an offer to purchase an uninspected asset, the asset comprising at least one item of real property;
the computer accessing a first set of information sources for a first data to provide to an at least one algorithm for generating the purchase offer, the first set of information sources comprising multiple listing services and property tax records;
the computer determining that the first data is inadequate to generate the offer;
the computer accessing a second set of information sources for a second data to provide to the at least one algorithm for generating the offer, the second data comprising at least one of physical dimensions of the real property, type of construction of the real property if any, and information about similar and neighboring properties; and
the computer generating and communicating the offer based at least on processing by the at least one algorithm of the second data, the offer containing a range of contingent purchase prices based on results of a future inspection of the asset, wherein one of the contingent purchase prices becomes a firm cash purchase price upon completion of the inspection.

16. The method of claim 15, further comprising the computer closing, upon acceptance of the offer and completion of the inspection, purchase of the asset at the firm purchase price determined based on the inspection.

17. The method of claim 15, further comprising the computer, based on proceeds realized during subsequent liquidation of the asset, refining the at least one algorithm.

18. The method of claim 15, wherein the range of contingent purchase prices comprises five contingent prices, each of the contingent purchase prices based on one of unlivable, poor, average, good, and excellent conditions of the asset determined based on the inspection

19. The method of claim 15, further comprising the computer receiving the request from a prospective seller, the request received by the computer via the world wide web of the Internet.

20. The method of claim 19, wherein the prospective seller provides a physical street address of the item of real property in a browser session with the computer.
